(19) United States
(12) Patent Application Publication
(10) Pub. No.: US 2023/0264964 A1
(43) Pub. Date: Aug. 24, 2023

(54) MODIFIED SILICAS, PROCESS FOR PREPARATION THEREOF AND USE THEREOF

(71) Applicant: Evonik Operations GmbH, Essen (DE)

(72) Inventors: Herbert THOMA, Swisttal (DE); Dominik MASCHKE, Erftstadt (DE); Rainer LAMANN, Bergheim (DE); Roland KRAFCZYK, Rheinfelden (DE); Andre WEHMEIER, Bornheim (DE); Caren ROEBEN, Essen (DE); Olga KUFELT, Ludwigshafen am Rhein (DE); Anke BLUME, Weilerswist (DE)

(73) Assignee: Evonik Operations GmbH, Essen (DE)

(21) Appl. No.: 18/004,139

(22) PCT Filed: Jul. 5, 2021
(86) PCT No.: PCT/EP2021/068488

§ 371 Date: Jan. 3, 2023

(30) Foreign Application Priority Data
Jul. 7, 2020 (DE) 10 2020 208 510.2

(51) Int. Cl. C01B 33/18; C08K 3/36; C08K 9/04

(52) U.S. Cl. CPC C01B 33/18; C08K 3/36; C08K 9/04; C01P 2006/12; C08K 2201/006; C01P 2006/14; C01P 2004/51; C01P 2006/80

(57) ABSTRACT

Modified silicas, having the following physicochemical parameters: a CTAB_{mod} of <200 m²/g, a BET_{MP} of 50-500 m²/g, a CTAB_{mod}-BET_{MP} of <0 m²/g, a carbon content of >0.5% by weight, a mode_{mod} from CPS particle size determination of >50 nm, a d75_{mod} from CPS particle size determination of 20-150 nm, a Rₘᵢₙ from Hg pore size determination, pressurized of <10 nm, and a sulfur content of ≤1.50% by weight.

The invention relates to modified silicas, to processes for preparation thereof and to the use thereof.

E. F. Vansant, P. Van der Voort, K. C. Vrancken, Characterization and chemical modification of the silica surface, Chemical Studies in Surface Science and Catalysis Vol. 93, Elsevier Verlag, 1995 discloses the chemical modification of silicas with various agents, for example organosilanes (p. 194-198; p. 266-270; p. 288-292).

Also known from DE 10138491 A1 and DE 10138492 A1 is the hydrophobization of precipitated silica, wherein the addition is made directly to the dryer. There is additionally a conditioning step.

WO2014033300 A1 discloses the modification of precipitated silicas with dicarboxylic acids.

A disadvantage of the known modified silicas is the rise in mixture viscosities and hence poorer processing of the rubber mixtures. Moreover, these are accompanied by a reduced processing window and a tendency to premature crosslinking, which additionally complicates processing in production. A further disadvantage that results from the pretreatment is the adverse effect on dynamic properties, and the worsened dispersion of fillers in the vulcanized materials.

It is an object of the present invention to provide a modified silica that, by comparison with in situ silanization or in situ modification, shows improved processing characteristics of the mixtures coupled with improved dynamic properties. In addition, the modified silicas have equal or improved quality of filler dispersion.

The invention provides modified silicas characterized by the following physicochemical parameters:

| | |
|---|---|
| CTAB_{mod} | <200 m²/g, preferably 20-150 m²/g, more preferably 50-150 m²/g, |
| BET_{MP} | 50-500 m²/g, preferably 80-250 m²/g, |
| CTAB_{mod} - BET_{MP} | <0 m²/g, preferably -100--10 m²/g, |
| carbon content | >0.5% by weight, preferably 1-10% by weight, |
| mode_{mod} from CPS particle | >50 nm, preferably 51-150 nm, more preferably 60-100 nm, |
| size determination | |
| d75_{mod} from CPS particle | 20-150 nm, preferably 50-100 nm, |
| size determination | |
| Rₘᵢₙ from Hg pore size | <10.0 nm, preferably <5.3 nm, more preferably 1.0-5.0 nm, |
| determination, pressurized | |
| sulfur content | ≤1.50% by weight, preferably ≥0.10% by weight- 1.50% |
| | by weight, more preferably ≥0.10% by weight- 1.30% by weight, |
| | most preferably ≥0.40% by weight - 1.30% by weight |

The modified silicas according to the invention may have a Ro-Tap value >150 μm of >80%, preferably >85%.

The modified silicas according to the invention may have a Ro-Tap value >300 μm of >50%, preferably >60%.

The modified silicas according to the invention may have a Ro-Tap value >500 μm of >20%, preferably >40%.

The modified silicas according to the invention may have a DOA absorption of 100-300 ml/(100 g), preferably 140-240 ml/(100 g).

The modified silicas according to the invention may have a drying loss of <4.5% by weight, preferably 2.0-4.0% by weight.

The modified silicas according to the invention may have a pH of ≥6.3, preferably 6.3-8.0.

The modified silicas according to the invention may have a TAR_{mod} value of >1%, preferably 15-70%.

The modified silicas according to the invention may have an ignition residue of 70-95%, preferably 80-95%.

The modified silicas according to the invention may have an IF value from Hg pore size determination, pressurized, of <170 Å, preferably 70-160 Å.

The modified silicas according to the invention may have an IS value from Hg pore size determination, pressurized, of ≤79 ml/(100 g), preferably 50-79 ml/(100 g).

The modified silicas according to the invention may have a PV value (V80, 3.7-80 nm, 140°) of ≤0.86 ml/g, preferably 0.30-0.86 ml/g.

The modified silicas according to the invention may be fumed or precipitated silicas, preferably precipitated silicas.

The invention further provides a process for preparing the modified silicas according to the invention, which is characterized in that silica is mixed with at least one additive selected from the group of aqueous sulfur-containing alkoxysilane emulsions, polysiloxanes such as preferably polydimethylsiloxane and side chain-modified derivatives thereof, mixture of sulfur-containing alkoxysilane and polydimethylsiloxane, and mixture of sulfur-containing alkoxysilane and anionic polyether, in the intake of the drying unit, and then supplied to the drying unit.

Preliminary mixing already takes place in the intake, by contrast with DE 10138491 A1 and DE 10138492 A1, where the additive is added directly to the dryer. In addition, in the present invention, a subsequent conditioning step as described in applications DE 10138491 A1 and DE 10138492 A1 is unnecessary.

The modified silica can be used without further conditioning steps.

The intake may be a conveying screw, preferably a twin screw, more preferably a non-meshing twin screw.

The silica used in the process according to the invention may have a BET_{MP} surface area of 50-300 m²/g, preferably of 80-280 m²/g. The CTAB surface area of the silica may be 40-280 m²/g, preferably 70-260 m²/g.

The silica may be a fumed or precipitated silica, preferably precipitated silica.

The sulfur-containing alkoxysilane may be an alkoxysilane of the formula (I)

[(RO)₃Si—R³—]ₙA (I)

where R is the same or different and is a straight-chain unsubstituted or branched unsubstituted (C1-C10)-alkyl, preferably (C1-C6)-alkyl, more preferably methyl or ethyl, or an alkyl polyether group —(R¹—O)ₘ—R² where R¹ is the same or different and is a branched or unbranched saturated aliphatic divalent C1-C30 hydrocarbon group, m has an average of 1 to 30, and R² is an unsubstituted branched or unbranched monovalent C1-C30-alkyl, C2-C30-alkenyl, C6-C30-aryl or C7-C30-aralkyl group, R³ is a branched or unbranched, saturated or unsaturated, aliphatic, aromatic or mixed aliphatic/aromatic divalent C1-C30 hydrocarbon group, n=1 or 2, when n=2 A is Sₓ with x=1-10, and when n=1 A is SH, SCN or SC(O)R.

The sulfur-containing alkoxysilane may preferably be bis[(3-triethoxysilyl)propyl] disulfide or (EtO)₃Si—(CH₂)₃—S—C(O)—C₇H₁₅.

The aqueous sulfur-containing alkoxysilane emulsion may be an emulsion of the alkoxysilane of the formula (I).

The aqueous sulfur-containing alkoxysilane emulsion may preferably be an emulsion of bis[(3-triethoxysilyl)propyl] disulfide. The aqueous sulfur-containing alkoxysilane emulsion used may be a 50% by weight bis[(3-triethoxysilyl)propyl] disulfide or bis[(3-triethoxysilyl)propyl] polysulfide emulsion with <0.5% by weight of nonionic surfactant.

The polysiloxane may be a modified or unmodified polydimethylsiloxane. The modified polydimethylsiloxane may contain polyether phosphate, alkyl ester or polyether groups. The polysiloxane used may be a polyethersiloxane.

The mixture of sulfur-containing alkoxysilane and polydimethylsiloxane may contain 0.1-50% by weight of polydimethylsiloxane.

The mixture of sulfur-containing alkoxysilane and anionic polyether may contain 0.1-50% by weight of polyether.

The polyether may be an anionically modified polyether; for example, the polyether may contain phosphate groups.

The drying unit may be a Henschel mixer or a spin-flash dryer.

The reaction in a Henschel mixer can be effected at temperatures of 80° C.-170° C., preferably 95° C.-145° C.

The reaction in a spin-flash dryer can be effected at exit temperatures of 70° C.-180° C., preferably 80° C.-170° C.

The preliminary distribution of the additive takes place not with simultaneous drying as described in DE 10138492 A1, but in the intake upstream of the dryer. This can be executed, for example, in the form of a high-shear, meshing twin screw.

The silica/additive weight ratio may be 100:1-100:15, preferably 100:3-100:10 and more preferably 100:4-100:8.

The invention further provides a rubber mixture comprising

(A) a rubber or a mixture of rubbers and

(B) at least one modified silica according to the invention.

Rubber used may be natural rubber and/or synthetic rubbers. Preferred synthetic rubbers are described for example in W. Hofmann, Kautschuktechnologie [Rubber Technology], Genter Verlag, Stuttgart 1980. They may include:
polybutadiene (BR),
polyisoprene (IR),
styrene/butadiene copolymers, for example emulsion SBR (E-SBR) or solution SBR (S-SBR), preferably having styrene contents of 1% to 60% by weight, more preferably 5% to 50% by weight (SBR),
chloroprene (CR),
isobutylene/isoprene copolymers (IIR),
butadiene/acrylonitrile copolymers having acrylonitrile contents of 5% to 60%, preferably 10% to 50%, by weight of (NBR),
partly hydrogenated or fully hydrogenated NBR rubber (HNBR),
ethylene/propylene/diene copolymers (EPDM),
abovementioned rubbers which also have functional groups, e.g. carboxy, silanol or epoxy groups, for example epoxidized NR, carboxy-functionalized NBR or silanol(—SiOH)— or siloxy(—Si—OR)-functionalized SBR,
   and mixtures of these rubbers.

In a preferred embodiment, the rubbers may be sulfur-vulcanizable. For the production of car tyre treads it is in particular possible to use anionically polymerized S-SBR rubbers (solution SBR) with a glass transition temperature above −50° C., and also mixtures of these with diene rubbers. It is possible with particular preference to use S-SBR rubbers wherein the butadiene component has a vinyl content of more than 20% by weight. It is possible with very particular preference to use S-SBR rubbers wherein the butadiene component has a vinyl content of more than 50% by weight.

It is preferably possible to use mixtures of the abovementioned rubbers which have an S-SBR content of more than 50% by weight, preferably more than 60% by weight.

The rubber mixture according to the invention may comprise additional fillers. The following fillers may be used as fillers for the rubber mixture according to the invention:
Carbon blacks: The carbon blacks may be produced by the lamp-black process, furnace-black process, gas-black process or thermal process and have BET surface areas of from 20 to 200 m²/g. The carbon blacks may optionally also contain heteroatoms, such as Si for example.
Amorphous silicas produced for example by precipitation from solutions of silicates or flame-hydrolysis of silicon halides with specific surface areas of from 5 to 1000 m²/g, preferably from 20 to 400 m²/g (BET surface area) and with primary particle sizes of from 5 to 400 nm. The silicas may optionally also be in the form of mixed oxides with other metal oxides, such as Al oxides, Mg oxides, Ca oxides, Ba oxides, Zn oxides and titanium oxides, and/or contain traces of up to 10 000 ppm of these metal ions.
Synthetic silicates, such as aluminium silicate, alkaline earth metal silicates such as magnesium silicate or calcium silicate, having BET surface areas of 20 to 400 m²/g and primary particle diameters of 10 to 400 nm.
Synthetic or natural aluminium oxides and synthetic or natural aluminium hydroxides.
Natural silicates, such as kaolin and other naturally occurring silicas.
Glass fibres and glass-fibre products (mats, strands) or glass microbeads.

It is possible with preference to use amorphous silicas prepared by precipitation from solutions of silicates, with BET surface areas of 20 to 400 m²/g, more preferably 100 m²/g to 250 m²/g, in amounts of 5 to 150 parts by weight, based in each case on 100 parts of rubber.

The fillers mentioned may be used alone or in a mixture.

The rubber mixture may comprise 5 to 150 parts by weight of modified silica according to the invention and 0.1 to 20 parts by weight, preferably 1 to 18 parts by weight, more preferably 5 to 15 parts by weight, of organosilane, where the parts by weight are based on 100 parts by weight of rubber.

The rubber mixture may additionally comprise silicone oil and/or alkylsilane. The rubber mixture may additionally comprise resins, modified resins and/or reactive resins.

The rubber mixture according to the invention may comprise other known rubber auxiliaries, for example crosslinking agents, vulcanization accelerators, reaction accelerators, reaction retarders, antioxidants, stabilizers including ageing stabilizers, processing aids, plasticizers, waxes or metal oxides, and also optionally activators such as triethanolamine, polyethylene glycol or hexanetriol.

The rubber auxiliaries may be used in customary amounts guided by factors including the end use. Customary amounts may, for example, be amounts of 0.1% to 50% by weight based on rubber.

Crosslinkers used may be sulfur or organic sulfur donors.

The rubber mixture according to the invention may comprise other vulcanization accelerators. Examples of suitable vulcanization accelerators that may be used include mercaptobenzothiazoles, sulfenamides, guanidines, dithiocarbamates, thioureas, thiocarbonates, and also zinc salts of these, for example zinc dibutyldithiocarbamate.

The rubber mixture according to the invention may additionally comprise

a thiuram sulfide accelerator and/or carbamate accelerator and/or the corresponding zinc salts,

a nitrogen-containing co-activator,

optionally other rubber auxiliaries and

optionally other accelerators.

The weight ratio by weight of accelerator to nitrogen-containing co-activator may be equal to or greater than 1.

The rubber mixture according to the invention may comprise at least 0.25 part by weight, based on 100 parts by weight of rubber, of tetrabenzylthiuram disulfide or tetramethylthiuram disulfide, at most 0.25 part by weight, based on 100 parts by weight of rubber, of diphenylguanidine, and cyclohexyl- or dicyclohexylsulfenamide.

It is possible with preference to use sulfenamides together with guanidines and thiurams, more preferably cyclohexylsulfenamide or dicylohexylsulfenamide together with diphenylguanidine and tetrabenzylthiuram disulfide or tetramethylthiuram disulfide.

The vulcanization accelerators and sulfur may be used in amounts of 0.1 to 10% by weight, preferably 0.1 to 5% by weight, based on the rubber used. It is possible with particular preference to use sulfur and sulfenamides in amounts of 1% to 4% by weight, thiurams in amounts of 0.2% to 1% by weight, and guanidines in amounts of 0% by weight to 0.5% by weight.

The invention further provides a process for preparing the rubber mixture according to the invention, which is characterized in that the rubber or mixture of rubbers, the modified silica according to the invention and optionally further rubber auxiliaries are mixed in a mixing unit.

The blending of the rubbers with the filler, any rubber auxiliaries and the modified silica according to the invention may be carried out in customary mixing units, such as rollers, internal mixers and mixing extruders. Rubber mixtures of this type can typically be produced in internal mixers, by first incorporating the rubbers, the filler, the modified silica according to the invention and the rubber auxiliaries by mixing at 100 to 170° C., in one or more sequential thermomechanical mixing stages. The sequence of addition and juncture of addition of the individual components may have a crucial effect on the resultant properties of the mixture. It is typically possible to admix the resultant rubber mixture with the crosslinking chemicals in an internal mixer or on a roll at 40 to 110° C. and to process the mixture to give what is known as the crude mixture for the subsequent steps of the process, for example shaping and vulcanization.

The rubber mixture may be used in the form of masterbatch and/or in a continuous mixing process. The rubber mixture may be produced via the route of what is called liquid phase mixing or continuous liquid phase mixing, or by the combination of masterbatches.

The rubber mixture according to the invention can be vulcanized at temperatures of 80° C. to 200° C., preferably 130° C. to 180° C., optionally at a pressure of 10 to 200 bar.

The rubber mixtures according to the invention can be used to produce shaped bodies by vulcanization.

The rubber mixture of the invention can be used for the production of mouldings, for example for the production of pneumatic tyres, cable sheathing, hoses, drive belts, conveyor belts, roll coverings, tyres, especially tyre treads, shoe soles, sealing elements, such as sealing rings and damping elements.

The modified silicas according to the invention have the advantage that the corresponding rubber mixtures have reduced Mooney viscosities, an extended processing window and hence an improvement in processibility. Moreover, the rubber mixtures according to the invention show improved dynamic properties and improved elongation at break, coupled with equal tensile strength, dispersion quality and abrasion resistance of the vulcanizates.

Test Methods:

CTAB—Determination of CTAB Surface Area in Accordance with ISO 5794-1-G

The method is based on the adsorption of buffered CTAB (N-cetyl-N,N,N-trimethylammonium bromide) in aqueous solution on the “outer” surface of silicas, which is also referred to as “rubber-active surface”. Unadsorbed CTAB is back-titrated by means of NDSS (dioctylsodium sulfosuccinate solution). The endpoint of the titration is at the maximum rise in opacity of the solution.

The procedure is in accordance with ISO 5794-1 G, with specifications, additions and departures as described below:
In the course of sample preparation, specimens of silicas and silicates in the form of coarse particles are preferably ultrafinely ground by means of a suitable mill or crushed with a mortar and pestle and sieved through a 90 μm sieve, not crushed with a mortar and pestle and fractionated by means of a 150 μm sieve as described in the standard.
The suspensions composed of test specimen and CTAB solution having an expected CTAB surface area of less than 200 m²/g are stirred for 10 minutes. The suspensions composed of test specimen and CTAB solution having an expected CTAB surface area of not less than 200 m²/g are stirred for 35 minutes, as described in the standard.
After the adsorption, the silica is filtered through a 0.2 μm polyamide filter.
The filtrate is titrated using a Metrohm titroprocessor with an autosampler and Tirando 809. The phototrode used is the Spectrosense 523 nm from Metrohm.

CTAB_{mod}—Determination of the Ethanolic CTAB Value—CTAB_{mod.} in Accordance with ISO 5794-1-G

The method is based on the adsorption of buffered CTAB (N-cetyl-N,N,N-trimethylammonium bromide) in aqueous ethanolic solution on the “outer” surface of hydrophobic silicas, which is also referred to as “rubber-active surface”. Unadsorbed CTAB is back-titrated by means of NDSS (dioctylsodium sulfosuccinate solution). The endpoint of the titration is at the maximum rise in opacity of the solution.

The procedure is in accordance with ISO 5794-1 G, with specifications, additions and departures as described below:
In the course of sample preparation, specimens of silicas and silicates in the form of coarse particles are preferably ultrafinely ground by means of a suitable mill (e.g. IKA M20 mill) or crushed with a mortar and pestle and sieved through a 75 μm sieve, not crushed with a mortar and pestle and fractionated by means of a 150 μm sieve as described in the standard.
To determine the blank value of the NDSS solution used, 5.00 ml of a mixture of (30.0±0.1) ml of CTAB solution and (10.0±0.1) ml of ethanol, and also 55 ml of deionized water, are pipetted into a titration beaker.
The fractionated sample material is weighed accurately to 0.1 mg into a 50 ml centrifuge tube with magnetic stirrer bar, and pre-wetted with 10.0 ml of ethanol. (30.0±0.1) ml of CTAB solution is subsequently metered in and stirred by magnetic stirrer for 20-25 minutes (35-40 minutes in the case of samples with expected CTAB values of greater than 200 m²/g).
By means of centrifugation at at least 4000 rpm and RCF 2500 for 15 minutes, solid-phase and liquid phase are separated after the adsorption.
The liquid phase is titrated using a Metrohm titroprocessor with an autosampler and Tirando 905. The phototrode used is the DP5 from Mettler-Toledo, working wavelength 555 nm.

BET_{MP}—Determination of Nitrogen BET Surface Area in Accordance with DIN ISO 9277

The method serves to determine the specific N2 surface area of silica by the BET method in accordance with DIN ISO 9277. In this method, the measurement is determined by low-temperature adsorption of nitrogen at defined partial pressures. The analysis is conducted as a multipoint determination and shows virtually linear behaviour in the partial pressure range (p/po) of 0.05-0.2 in the case of determination of 5 measurement points in total.

The procedure is in accordance with DIN ISO 9277 with the specifications described below:

Granulated samples, before being weighed out, are cautiously crushed with a spatula and then degassed under reduced pressure using the Micromeritics Vac Prep 061 evacuated degassing thermostat at (160+/−2)° C. for 60 minutes.

For determination of the BET surface area, the following 5 relative pressure points (p/po) are recorded during the adsorption phase: 0.0500; 0.0875; 0.1250; 0.1625 and 0.2000.

For the measurements, the TriStar 3000 series (3000/3020/3030) from MICROMERITICS with a static volumetric test method and a Dewar vessel is used.

Carbon Content—Determination of Carbon Content in Accordance with DIN EN ISO 3262-19

The determination is conducted with elemental analysers from LECO (instrument type CS-200 and CS-600) with external evaluation unit (PC with LECO software) in accordance with DIN EN ISO 3262-19.

The sample is weighed out in a ceramic crucible, an oxidation catalyst with combustion accelerator (e.g. Lecocel II from LECO) and an induction agent (e.g. ultrapure iron turnings from LECO) are added, and the sample is combusted in the induction oven of the element analyser. The carbon in the sample is oxidized here in the oxygen stream to CO₂. The gas is quantified by means of infrared detection. For the handling, maintenance and adjustment of the analyser, the instructions and descriptions in the operation handbook from LECO are applicable.

Calibration is accomplished using BAM steel standards No. 289-1, No. 130-1 and No. 283-1. The standards and the starting weights should be chosen such that the masses of carbon of the test specimens are within the calibration range. Calibration is accomplished by calculating a calibration line comprising at least 4 calibration points.

Sulfur Content—Total Sulfur—Determination on Silica Test Specimens in Accordance with DIN EN ISO 3262-19 or ASTM D 6741 Method B.

a. Determination Method for Unmodified Silica

The determination is conducted with elemental analysers from LECO (instrument type CS-200 and CS-600) with external evaluation unit (PC with LECO software) in accordance with DIN EN ISO 3262-19.

The sample is weighed out in a ceramic crucible, an oxidation catalyst with combustion accelerator (e.g. Lecocel II from LECO) and the induction agent (e.g. ultrapure iron turnings from LECO) are added, and the sample is combusted in the induction oven of the element analyser. The sulfur in the sample is oxidized here in the oxygen stream to SO₂. The gas is quantified by means of infrared detection. For the handling, maintenance and adjustment of the analyser, the instructions and descriptions in the operation handbook from LECO are applicable.

Calibration is accomplished using BAM steel standards No. 289-1, No. 130-1 and No. 283-1. The standards and the starting weights should be chosen such that the masses of sulfur of the test specimens are within the calibration range. Calibration is accomplished by calculating a calibration line comprising at least 4 calibration points.

b. Determination Method for Modified Silica

The sulfur content is determined with the Leco SC-144 DR total sulfur analyser. The sample is combusted at 1350° C. in an oxygen stream; the SO₂ formed is quantified by means of infrared measurement cells. The method is in accordance with ASTM D 6741 Method B.

For the measurement, test specimens and calibration substances are weighed into boats, which are pushed into the combustion tube of the sulfur analyser. In the case of liquid calibration substances and samples, the base of the boat is covered with about 2 g of sea sand before the sample is weighed out. The sample weighed out is covered with a further portion of sea sand (about 1 g). The calibration substances and the amount of sample should be chosen and matched to one another such that the amounts weighed out are as far as possible within a range between 0.1 and 0.2 g. The sample weight should be about 150 mg. In the case of pelletized samples, the material is homogenized before the measurement (e.g. by crushing, mortar and pestle, etc.).

The standard starting weights for the calibration should be chosen within the expected measurement range for the test specimens. Before use, the standards must be dried at 105° C. for 2 hours. The choice of standards is guided by the expected sulfur content of the sample:

For calibration of test specimens with not more than 2.5% sulfur, the following calibration substances are used:

502-671 Coal Standard, about 1% sulfur; from Leco

502-422 White Oil Standard, about 2% sulfur; from Leco

For calibration of test specimens with more than 2.5% sulfur, the following calibration substance is used:

Sulfanilic acid standard, from Eltra

Calibration is accomplished by calculating a calibration line comprising at least 4 calibration points. The test results are evaluated and calculated by means of LECO instrument software.

D75_{mod} or mode_{mod}—Determination of the Particle Size Distribution of Modified Silica after Deagglomeration by Ultrasound Energy by Means of a Disc Centrifuge

The sample to be analysed is dispersed in a propane-1,2-diol/water mixture, deagglomerated with ultrasound energy and subsequently separated according to particle size in a disc centrifuge: The analysis is conducted on a DC24000 disc centrifuge from CPS Instruments.

The disc centrifuge is set to a speed of 20 000 rpm.

By way of preparation, the running disc centrifuge is filled with a density gradient of sucrose solutions with added propane-1,2-diol and Nonidet (Nonidet P40, from AppliChem GmbH), and covered with a dodecane top layer.

The concentrations of the sugar solutions here are between w=8% and w=24% sucrose. The density gradient is built up in ten stages:

24.0%/22.2%/20.4%/18.7%/16.9%/15.1%/13.3%/11.6%/9.8%/8.0%

For this purpose, two sugar solutions with the following composition are prepared:

High-density solution: 24% aqueous sucrose solution+0.2% Nonidet

Low-density solution: 8% aqueous sucrose solution+24% propane-1,2-diol+0.2% Nonidet

1.8 ml of sugar solution for each density stage is injected into the disc centrifuge, commencing with the highest concentration. For this purpose, the two sugar solutions are mixed with one another as follows in the required ratios in a dosage syringe:

| | | | |
|---|---|---|---|
| 24% | 1.8 ml | 8% | 0.0 ml |
| 24% | 1.6 ml | 8% | 0.2 ml |
| 24% | 1.4 ml | 8% | 0.4 ml |
| 24% | 1.2 ml | 8% | 0.6 ml |
| 24% | 1.0 ml | 8% | 0.8 ml |
| 24% | 0.8 ml | 8% | 1.0 ml |
| 24% | 0.6 ml | 8% | 1.2 ml |
| 24% | 0.4 ml | 8% | 1.4 ml |
| 24% | 0.2 ml | 8% | 1.6 ml |
| 24% | 0.0 ml | 8% | 1.8 ml |

Finally, 0.5 ml of dodecane is injected.

0.10 g (±0.01 g) of the sample is weighed into a 30 ml snap-lid vial, and 15 ml of a solution consisting of 24% propane-1,2-diol+0.2% Nonidet in deionized water is added.

The filled snap-lid vial is fixed in a cooling bath (Julabo F12) with the aid of a clamp. The cooling bath has been pre-equilibrated to a temperature of 5° C. (±1° C.). The ultrasound probe (from Hielscher; UP200S with S14 sonotrode) is positioned such that the sonotrode is immersed 5.5 cm into the vial —measured from the upper edge of the snap-lid vial. The sample is subjected to continuous sonication at 100% power for 15 min.

Procedure
For the measurements, the following parameters should be established in the instrument's dedicated software:
Sample parameters (decimal places in the description of the software are given as points and not as commas):

### Notes:

| Maximum Diameter | 5.0 | microns |
|---|---|---|
| Minimum Diameter | 0.02 | microns |
| Particle Density | 2.11 | g/ml |
| Particle Refractive Index | 1.46 | |
| Particle Absorption | 0.001K | |
| Non-Sphericity Factor | 1.0 | |
| Calibration Standard Parameters: | | |
| Peak Diameter | xxx | microns ¹) |
| Half Height Peak Width | 0.15 | microns |
| Particle Density | 1.385 | g/ml ¹) |
| Fluid Parameters: | | |
| Fluid Density | 1.075 | g/ml |
| Fluid Refractive Index | 1.3706 | |
| Fluid Viscosity | 2.0 | cps |

| | |
|---|---|
| Presentation Parameters: | |
| Display Mode | Weight |
| X-axis Scale | Log |

¹) depending on the calibration standard used, input corresponding to the manufacturer specification (e.g. PVC reference standard, from CPS Instruments).

The measurement wavelength is set to 470 nm.
0.1 ml of the standard or of the sample suspension is injected in each case. A double determination (including dispersion) is conducted for each sample to be analysed.

Result
The raw data curve (absorption measurement) is used to ascertain a weight distribution with the instrument's dedicated software. The following are reported:
   Mode_{mod} (in nm)—most common particle size, corresponding to the abscissa value of the maximum of the logarithmic distribution function;
   D_{75,mod} (75th oversize weight percentile) (in nm)—particle size at which 75% of the distribution is above (from cumulative curve);

D75 or mode_{mod}—Determination of the Particle Size Distribution of Silica After Deagglomeration by Ultrasound Energy by Means of a Disc Centrifuge

The sample to be analysed is deagglomerated with ultrasound energy in an aqueous suspension and subsequently separated according to particle size in a disc centrifuge: The analysis is conducted with a DC24000 disc centrifuge from CPS Instruments.

The determination is conducted analogously to the method for modified silica at a speed of 20 000 rpm.

In a departure, the density gradient is built up in nine stages with the following concentrations of the sugar solutions (between w=8% and w=24% sucrose):

24%/22%/20%/18%/16%/14%/12%/10%/8%

1.6 ml of sugar solution for each density stage is injected into the disc centrifuge, commencing with the highest concentration. Finally, 0.5 ml of dodecane is injected.

Prior to the determination, the samples are ultrafinely ground with a mill (Fritsch mill; Pulverisette 14 with 80 μm sieve). 0.75 g (±0.05 g) of the ground material is weighed out into a 30 ml snap-lid vial, and 15 ml of deionized water is added.

In a departure, the following parameters are set for the measurement in the instrument's dedicated software:
Sample parameters (decimal places in the description of the software are given as points and not as commas):

| Maximum Diameter | 5.1 | microns |
|---|---|---|
| Minimum Diameter | 0.02 | microns |
| Particle Density | 2.0 | g/ml |
| Particle Refractive Index | 1.44 | |
| Particle Absorption | 0.001K | |
| Non-Sphericity Factor | 1.1 | |
| Calibration Standard Parameters: | | |
| Peak Diameter | xxx | microns ²) |
| Half Height Peak Width | 0.2 | microns |
| Particle Density | 1.385 | g/ml ¹) |
| Fluid Parameters: | | |
| Fluid Density | 1.045 | g/ml |
| Fluid Refractive Index | 1.344 | |
| Fluid Viscosity | 1.2 | cps |

| | |
|---|---|
| Presentation Parameters: | |
| Display Mode | Weight |
| X-axis Scale | Log |

²⁾ Depending on the particular calibration standard.

The evaluation is analogous to the method described for modified silica.

Drying Loss—Determination of Drying Loss to DIN EN ISO 787-2

The weight loss of a sample heated at 105° C. in a drying cabinet for 2 h is determined.

The procedure is in accordance with DIN EN ISO 787-2 with the specifications described below:

The weighing bottle (with flanged lid; diameter about 80 mm, height about 30 ml) is heated at 105° C. with the lid off for about 1 h. After cooling in a desiccator, the lid is inserted. The weight is determined accurately to 0.01 g on a precision balance. 5-10 g of the sample (weight depending on the bulk density) is weighed out accurately and spread out on the base of the weighing bottle in a uniform layer. The weighing bottle is cautiously opened and heated at (105±2)° C. in a drying cabinet for 2 h (lid is heated as well).

The weighing bottle is cautiously closed with the lid and left to cool in a desiccator and reweighed accurately to 0.01 g.

Calculation

$$Volatile fractions / \% = \frac{( E - A ) \cdot 100 \%}{E}$$

E=starting weight in g
A=final weight in g

pH—pH of Silicas in Accordance with DIN EN ISO 787-9

a. Determination Method for Unmodified Silica

The procedure is in accordance with DIN EN ISO 787-9 with the specifications described below:

Granulated sample material is pulverized by mortar and pestle before being weighed out.

A 5% (m/m) aqueous suspension of the sample to be analysed is prepared. For this purpose, demineralized (DMPA) water is used.

Before the measurement of pH, the sample suspension is agitated on an agitator for at least 5 minutes.

The pH is measured on a previously calibrated pH meter from Metrohm, model 780 with pH electrode 6.0228.000 (from Metrohm).

b. Determination Method for Modified Hydrophobic Silica

The procedure is in accordance with DIN EN ISO 787-9 with the specifications and departures described below:

Granulated sample material is pulverized by mortar and pestle before being weighed out.

5 g of the sample to be analysed is weighed out. To this are added 40 ml of demineralized (DM) water and 60 ml of methanol p.a.

Before the measurement of pH, the sample suspension is agitated on an agitator for at least 5 minutes.

The pH is measured on a previously calibrated pH meter from Metrohm, model 780 with pH electrode 6.0228.000 (from Metrohm).

c. Determination Method for Modified Hydrophilic Silica

The procedure is in accordance with DIN EN ISO 787-9 with the specifications described below:

Granulated sample material is pulverized by mortar and pestle before being weighed out.

A 5% (m/m) aqueous suspension of the sample to be analysed is prepared. For this purpose, boiled demineralized (DMPA) water is used.

Before the measurement of pH, the sample suspension is agitated on an agitator for at least 5 minutes.

The pH is measured on a previously calibrated pH meter from Metrohm, model 780 with pH electrode 6.0228.000 (from Metrohm).

TAR—Granule Abrasion by Friability Test for Unmodified Silica

For abrasion by granule friability test, the fine and coarse fractions of the silica are removed and the 3.15-5.00 mm fraction is used. The granule fraction is subjected to repeated mechanical stress in a rotating friability chamber (e.g. ERWEKA TAR 220 with friability drums on the left and right) for 30 minutes. Subsequently, the resultant fines fraction is removed by means of a 500 μm sieve. The difference in mass in % corresponds to the granule abrasion.

The determination of the abrasion is conducted in duplicate. Sieving-out of the 3.15-5.00 mm grain fraction by cautious manual sieving (analytical sieves with metal sieve mesh, ISO 3310-1, sieve diameter 200 mm—nominal mesh size 500 μm, 3.15 mm and 5.00 mm, and sieve pan). This excludes fines and very coarse particles. (5.00±0.1) g of the 3.15-5.00 mm fraction is weighed out accurately on an analytical or precision balance. A representative portion of the sample must be taken. The sample is introduced into the friability drum; this is mounted on the abrasion tester. The instrument is operated at 65 rpm for 30 minutes. Subsequently, the material is applied quantitatively to a 500 μm sieve, and the adhering fines fraction is removed by moderate agitation/movement for 3-5 seconds. The granule particles are then reweighed accurately to 0.01 g on the precision or analytical balance.

Evaluation

$$Abrasion ( \% ) = \frac{( E - A ) * 100 \%}{E}$$

Abrasion: abrasion by granule friability test in %

E: starting weight of the 3.15-5.00 mm (or 1.00-3.15 mm) fraction sieved out in g

A: residue after stress and removal of the fines in g

The measurement result is the average from two individual measurements and is reported in % with one post-decimal place.

TAR_{mod}—Granule Abrasion by Friability Test for Modified Silica

Analogously to the above-specified TAR determination for unmodified silicas, however, the fine and coarse fractions of the silica are removed and the 1.00-3.15 mm fraction is used.

Ignition Residue—Determination of Ignition Residue of Silica in Accordance with ISO 3262-1 or ASTM D 6740

a. Determination Method for Unmodified Silica (ISO 3262-1)

By igniting the precipitated silica at 1000° C. in an ignition furnace for 2 h, the total water content (physically and chemically bound) and hence the content of all volatile components (ignition loss) is determined, from which it is also possible to calculate the ignition residue.

Determination Procedure

About 500 mg in each case of silica is weighed out in two porcelain crucibles or melting crucibles with the aid of a spatula on an analytical balance having an accuracy of ±0.1 mg. Subsequently, the crucibles together with silica are subjected to ignition in an ignition furnace at (1000±50)° C. for (120 ±5) min.

After the ignition, the crucibles are placed into a desiccator with a suitable desiccant for cooling for about 1.5-2.0 h and reweighed with an analytical balance. The determination is performed in duplicate.

Evaluation

First of all, the ignition loss (IL_{(dried)}) is calculated based on the dried matter:

$${IL}_{( dried )} = \frac{{m}_{E} \cdot \frac{100 - D L}{100} - {m}_{A}}{{m}_{E} \cdot \frac{100 - D L}{100}} \cdot 100$$

| | | |
|---|---|---|
| IL_{(dried)}: | Ignition loss based on matter dried at 105° C. for 2 h | in % |
| m_{E}: | Mass of silica weighed out | in g |
| m_{A}: | Mass of silica after ignition | in g |
| DL: | Drying loss at 105° C. for 2 h | in % |

Ignition residue (IR_{(orig.)}) based on original matter is calculated as follows for the ignition loss based on original matter (IL_{(orig.)}):

| | |
|---|---|
| IL_{(orig.)} = IL(_{dried}) * (100 − DL)/100 | in % |
| and therefore | |
| IR_{(orig.)} = 100% − DL − IL_{(orig.)} | in % |

For this purpose, drying loss is determined by the method of “Determination of drying loss to DIN EN ISO 787-2” (see above).

b. Determination Method for Modified Silica (ASTM D 6740)

The residue consists essentially of SiO₂, which forms in the breakdown of silanes and in the ignition of silicas. The method is in accordance with ASTM D 6740.

About (0.5-1.0) g¹ of the sample to be analysed is weighed into the previously calcined crucible with an accuracy of 0.1 mg. About 2 ml of 90% sulfuric acid is added and the crucible is cautiously tilted for mixing. ¹ The starting weight should be chosen that the mass of the residue is more than 100 mg.

The crucible is placed into the preliminary ashing apparatus (model: SVR/E, controllable up to 2500 watts) and heated up gradually, commencing at 10% (=250 watts). After removal of the acid (sample virtually dry), the preliminary ashing apparatus is heated up to the maximum temperature. Subsequently, the crucible is placed into a preheated muffle furnace (1000° C.) for 2 h. If the ash is still grey or black in colour thereafter, ignition is continued at 1000° C. for a further 2 h. The crucible is left to cool in a desiccator and weighed accurately to 0.1 mg.

Calculation
The ignition residue R is calculated as follows:

$$R ( \% ) = \frac{{m}_{2}}{{m}_{1}} \cdot 100$$

m₁=sample weight in g
m₂=mass of residue in g
(Ignition loss V in % is found as V=100−R)

PV (V80, 3.7-80 nm, 140°), IF (140°, dV/dR), IS (90%, 140°, dV/dR), Rₘᵢₙ (90%, 140°, dV/dR)—Determination of Pore Radii and Pore Volumes Based on Hg Intrusion in Accordance with DIN 66133

In a pressure range from 0.03 to 420 MPa, the pore radio, the corresponding pore volume and the pore distribution of pressurized silica samples are ascertained. The determination is effected with the Micromeritics AutoPore IV 9520 to DIN 66133.

In a departure from DIN 66133, the silica sample is subjected to a pressure treatment prior to the measurement. This is done using the Specac Atlas Manual 15 ton hydraulic press. A pellet die of internal diameter 13 mm from Specac Ltd. is charged with 1 g of sample and pressurized with 1 t according to the display. This load is maintained for 1 min. The sample is then decompressed and dried in a drying cabinet at 105±2° C. for 2 h.

For the measurement, the sample prepared is weighed out into the Micromeritics model 16 penetrometer. About 330 mg is weighed out accurately to 0.001 g. Subsequently, the penetrometer is evacuated gradually to 50 μm Hg in the low-pressure port of measuring instrument and left at that pressure for 5 min. Subsequently, the penetrometer is filled with mercury first in the low-pressure port and then in the high-pressure port up to a pressure of 420 MPa, and the measurement curve (pressure/volume curve) is recorded. The Autopore instrument is operated in accordance with the operating instructions from Micromeritics and is software-controlled. Each measurement is corrected by a blank measurement of the penetrometer. The overall measurement range is 0.003-420 MPa.

The measurement results are calculated from the measurement curve using the standard values according to DIN 66133:

Contact angle: 140°

Surface tension: 480 dyn/cm

The following parameters are evaluated:

PV (V80, 3.7-80 nm, 140°)

IF (140°, dV/dR)

IS (90%, 140°, dV/dR)

Rₘᵢₙ (90%, 140°, dV/dR)

Ro-Tap (>150 μm; >300 μm; >500 μm)—Sieve analysis in accordance with ISO 5794-1 Annex F

Sieve analysis is effected with a rotary sieving machine (Tyler Ro-Tap RX-29 analytical sieving machine with timer switch). The method is conducted in accordance with ISO 5794-1 Annex F. For the sieve analysis, the test sieves with various mesh sizes are stacked one on top of another (analytical sieve with metal sieve mesh, ISO 3310-1, nominal mesh size 150 μm, sieve diameter 200 mm, analytical sieve with metal sieve mesh, ISO 3310-1, nominal mesh size 300 μm, sieve diameter 200 mm, analytical sieve with metal sieve mesh, ISO 3310-1, nominal mesh size 500 μm, sieve diameter 200 mm). After a sieving time of 5 minutes, the corresponding fractions are weighed.

The sieve tower is built in the Ro-Tap sieving machine. The sequence from the bottom upward is as follows: sieve pan, 150 μm sieve, 300 μm sieve and 500 μm sieve. The sample is gently homogenized prior to the determination. (100±1) g is weighed accurately to 0.01 g into a beaker on a precision balance, and the sample is transferred quantitatively onto the uppermost sieve (500 μm). Ro-Tap sieving is conducted with a tapper (5 min±5 s). After sieving has ended, the sieving tower is removed and the fractions on the 150 μm, 300 μm and 500 μm sieves are weighed.
Calculation

Ro−Tap>500 μm (in %)=(A₅₀₀·100%)/E

and also

Ro−Tap>300 μm (in %)=(A₃₀₀·100%)/E

and

Ro−tap>150 μm (in %)=(A₁₅₀·100%)/E
A₅₀₀=residue on the 500 μm sieve in g
A₃₀₀=residue on the 300 μm sieve in g
A₁₅₀=residue on the 150 μm sieve in g
E=starting weight in starting weight in g
Departures from ISO 5794-1 Annex F

In a departure from the standard, according to this test instruction, sieves having a mesh size of 150 μm, 300 μm and 500 μm are used.

DOA Absorption—Determination of DOA Absorption in Accordance with ISO 19246

For performance, 12.50±0.02 g of the sample is introduced into the kneader chamber of the Brabender Absorptometer E with extended functionality/evaluation unit. Then, with constant kneading, dioctyl adipate (e.g. Plastomoll® DOA) is metered in at a metering rate of 4 ml/min. The kneader speed is 125 rpm. The program uses the raw data curve to calculate a polynomial. The 70% value of maximum torque of this polynomial serves to ascertain the DOA absorption based on original material in ml/(100 g). The determination is effected in accordance with ISO 19246.

In the case of silica granules, the determination is effected using the 1.00-3.15 mm grain fraction that has to be produced beforehand by sieving with the appropriate sieves.

The following settings should be made in the measuring instrument software:

Test Condition

Metering rate (burette): 4.0 ml/min

Kneader speed: 125 min−1

Temperature: 23.0° C.

Evaluation

End of Experiment

Torque threshold: 100 mNm

End: 60 s after max.

Torque limit: 10 000 mNm

Polynomial

Start: 50% of max. torque

End: 20 s after max.

Using suitable reference materials of different DOA absorption, it is possible with the aid of the Brabender® software to conduct individual standardization of the analytical kneader. Based on the standardization function ascertained (linear equation Y=a*x+b), the DOA absorption (standardized) based on original substance in ml/(100 g), expressed as the 70% value of the torque maximum, is taken from the measurement report.

### EXAMPLES

The reference silicas used are the silicas or modified silicas that follow (Table 1). The unit phf (parts per hundred filler) means parts by weight of additive based on 100 parts by weight of silica:

Silica 1 is ULTRASIL® 9100 GR from Evonik Resource Efficiency GmbH.

Silica 2 is prepared according to Example 1 from EP 1525159 B1.

Silica 3 is ULTRASIL® 7000 GR from Evonik Resource Efficiency GmbH.

Silica 4 is ZEOSIL® Premium 200 MP from Solvay.

Silica 5 is ZEOSIL® 1165 MP from Solvay.

Silica 6 is prepared according to Example 4 from EP 0901986 B1.

Silica 7 is Ciptane™ LP from PPG Industries Ohio, Inc.

Silicas 8+9 are Agilon® 400 and Agilon® 458 from PPG Industries Ohio, Inc.

Silica 10 is prepared according to Example 1 from WO2014033300 A1.

Silica 11 is COUPSIL® 8113 GR from Evonik Resource Efficiency GmbH.

Silica 12 is based on Example 4 silica from EP 0901986 B1, modified with 5 phf Si 69®.

Silica 13 is based on Example 4 silica from EP 0901986 B1, modified with 10 phf Si 69®.

TABLE 1

| Silica | | 1 | 2 | 3 | 4 | 5 | 6 | 7 | 8 | 9 | 10 | 11 | 12 | 13 |
|---|---|---|---|---|---|---|---|---|---|---|---|---|---|---|
| Additives | | — | — | — | — | — | — | | | | 0.33% by | COUP | | |
| | | | | | | | | | | | weight of | SIL ® | | |
| | | | | | | | | | | | Al + 1.1% | 8113 | | |
| | | | | | | | | | | | by weight | GR | | |
| | | | | | | | | | | | of DBA | | | |
| | | | | | | | | | | | based | | | |
| | | | | | | | | | | | on SiO₂ | | | |
| Drying loss | % | 5.9 | 4.3 | 4.8 | 5.1 | 6.4 | 4.0 | 5.6 | 4.3 | 5.5 | 3.9 | 3.6 | 1.9 | 2.3 |
| pH | — | 6.7 | 6.9 | 6.7 | 6.0 | 6.4 | 6.8 | 7.0 | 6.1 | 6.0 | 5.3 | 6.6 | 7.0 | 7.1 |
| BET_{MP} | m²/g | 228 | 235 | 170 | 206 | 153 | 165 | 76 | 77 | 113 | 150 | 128 | 146 | 133 |
| CTAB | m²/g | 202 | 201 | 158 | 203 | 159 | 156 | | | | | | | |
| CTAB_{mod.} | m²/g | 123 | 124 | 98 | 126 | 95 | | 90 | 87 | 125 | 96 | 82 | 91 | 85 |
| CTAB_{mod.} − | | −105 | −111 | −72 | −80 | −58 | −165 | 14 | 10 | 12 | −54 | −46 | −55 | −48 |
| BET_{MP} | | | | | | | | | | | | | | |
| DOA, | ml/ | 209 | 225 | 200 | 208 | 202 | 212 | 191 | 197 | 164 | 198 | 126 | 184 | 174 |
| original | (100 g) | | | | | | | | | | | | | |
| TAR_{mod} | % | | | | | | | | | 22.0 | 23.7 | 15.6 | 16.8 | 24.3 |
| TAR | % | 20.7 | 21.2 | 17.6 | | | 22.5 | | | | | | | |
| C content | % | <0.1 | <0.1 | 0.1 | <0.1 | <0.1 | <0.1 | 4.2 | 4.2 | 6.3 | 0.5 | 4.2 | 1.8 | 3.4 |
| Sulfur | % | 0.20 | 0.14 | 0.21 | 0.37 | 0.28 | 0.13 | 0.70 | 0.70 | 0.80 | 0.28 | 3.67 | 1.79 | 2.78 |
| content | | | | | | | | | | | | | | |
| Ignition | % | 90.6 | 92.0 | 91.7 | 91.1 | 89.2 | 92.7 | 90.6 | 86.5 | 84.0 | 92.8 | 86.8 | 90.7 | 88.4 |
| residue | | | | | | | | | | | | | | |
| Mode from | nm | 77 | 80 | 87 | 85 | 81 | 86 | | | | | | | |
| CPS | | | | | | | | | | | | | | |
| d75 from | nm | 63 | 66 | 77 | 68 | 68 | 71 | | | | | | | |
| CPS | | | | | | | | | | | | | | |
| Mode_{mod} | nm | | | | | | | 75 | 104 | 79 | 80 | 75 | 80 | 79 |
| from CPS | | | | | | | | | | | | | | |
| d75_{mod} | nm | | | | | | | 60 | 92 | 67 | 65 | 62 | 62 | 64 |
| from CPS | | | | | | | | | | | | | | |
| IF (140°, | Å | 87.9 | 77.5 | 106.5 | 86.9 | 111.1 | 118.0 | 102.5 | 203.3 | 123.4 | 116.4 | 107.7 | 113.9 | 111.0 |
| dV/dR) | | | | | | | | | | | | | | |
| IS (90%, | ml/ | 81.0 | 76.9 | 73.3 | 88.1 | 76.6 | 83.0 | 72.3 | 72.4 | 68.9 | 82.5 | 69.9 | 75.2 | 70.3 |
| 140°, | (100 g) | | | | | | | | | | | | | |
| dV/dR) | | | | | | | | | | | | | | |
| PV (V80, | ml/g | 0.90 | 0.84 | 0.80 | 0.98 | 0.87 | 0.92 | 0.83 | 0.74 | 0.75 | 0.90 | 0.77 | 0.81 | 0.78 |
| 3.7 − 80 nm, | | | | | | | | | | | | | | |
| 140°) | | | | | | | | | | | | | | |
| Rₘᵢₙ (90%, | nm | 3.45 | 1.75 | 2.67 | 1.52 | 4.52 | 3.04 | 4.09 | 7.07 | 5.65 | 4.12 | 3.62 | 3.73 | 4.84 |
| 140°, | | | | | | | | | | | | | | |
| dV/dR) | | | | | | | | | | | | | | |

Inventive silicas 14-21 are produced by preliminary mixing of the starting silica and the additives in a conveying screw, followed by drying in a Henschel mixer (Henschel FM 40 fluid mixer from Thyssen). For Examples 14-21, 3000 g of the starting silica that had been prepared according to Example 4 from EP 0901986 B1 was used. The additives are used in accordance with the recipe (Table 2). The mixer is preheated to 100° C. After the silica/additive mixture has been fed in, it is dried in the Henschel mixer at 2500 rpm for a period of 4 min.

In Examples 14, 16, 18 and 20, the modified silica was then compacted in a roll compactor.

Table 2 shows the composition of the modified silicas according to the invention. The unit phf (parts per hundred filler) means parts by weight of additive based on 100 parts by weight of silica. Si 266® is bis[(3-triethoxysilyl)propyl] disulfide from Evonik Resource Efficiency GmbH. NXT is (EtO)₃Si—(CH₂)₃—S—C(O)—C₇H₁₅ from Momentive.

TABLE 2

| Example | Composition |
|---|---|
| 14/15 | Silica from Example 4 of EP 0901986 B1 |
| | + 8.0 phf Si 266 ® |
| | + 17.3 phf anionically modified polyether |
| | (TEGOMER ® DA 640) |
| 16/17 | Silica from Example 4 of EP 0901986 B1 |
| | + 8.0 phf Si 266 ® |
| | + 11.6 phf alkyl-modified polysiloxane |
| | (TEGOPREN ® 6875-45) |
| 18/19 | Silica from Example 4 of EP 0901986 B1 |
| | + 8.0 phf Si 266 ® |
| | + 5.2 phf polyether-modified polysiloxane |
| | (TEGOPREN ® 5885) |
| 20/21 | Silica from Example 4 of EP 0901986 B1 |
| | + 9.0 phf NXT silane |
| | + 17.3 phf anionically modified polyether |
| | (TEGOMER ® DA 640) |

Table 3 shows the analytical data of the modified silicas according to the invention.

TABLE 3

| Silicas | | 14 | 15 | 16 | 17 | 18 | 19 | 20 | 21 |
|---|---|---|---|---|---|---|---|---|---|
| Additives | | 8 phf | 8 phf | 8 phf | 8 phf | 8 phf | 8 phf | 9 phf NXT | 9 phf NXT |
| | | Si 266 | Si 266 | Si 266 | Si 266 | Si 266 | Si 266 | silane | silane |
| | | 5.2 phf | 5.2 phf | 11.6 phf | 11.6 phf | 5.2 phf | 5.2 phf | 5.2 phf | 5.2 phf |
| | | TEGOMER | TEGOMER | TEGOPREN | TEGOPREN | TEGOPREN | TEGOPREN | TEGOMER | TEGOMER |
| | | DA 640 | DA 640 | 6875-45 | 6875-45 | 5585 | 5585 | DA 640 | DA 640 |
| Drying loss | % | 3.4 | 3.5 | 3.0 | 3.6 | 2.7 | 3.5 | 3.0 | 2.9 |
| pH | — | 7.2 | 7.2 | 7.1 | 7.1 | 7.1 | 7.1 | 7.6 | 7.6 |
| BET_{MP} | m²/g | 129 | 122 | 100 | 95 | 116 | 108 | 106 | 105 |
| CTAB_{mod.} | m²/g | 72 | 74 | 78 | 66 | 72 | 68 | 82 | 78 |
| CTAB_{mod.} − | m²/g | −57 | −48 | −22 | −29 | −44 | −40 | −24 | −27 |
| BET_{MP} | | | | | | | | | |
| DOA, | ml/ | 152 | 179 | 142 | 159 | 148 | 170 | 154 | 192 |
| original | (100 g) | | | | | | | | |
| TAR_{mod} | % | 49.0 | | 44.0 | | 54.7 | | 37.0 | |
| C content | % | 3.1 | 3.1 | 5.5 | 5.5 | 4.2 | 4.2 | 6.0 | 6.0 |
| Sulfur | % | 1.27 | 1.27 | 1.23 | 1.23 | 1.23 | 1.23 | 0.95 | 0.95 |
| content | | | | | | | | | |
| Ignition | % | 89.4 | 90.7 | 87.1 | 88.6 | 88.6 | 90.2 | 85.7 | 85.7 |
| residue | | | | | | | | | |
| Mode_{mod} | nm | 78 | 82 | 78 | 82 | 78 | 82 | 75 | 82 |
| from CPS | | | | | | | | | |
| d75_{mod} | nm | 66 | 70 | 66 | 71 | 66 | 71 | 60 | 67 |
| from CPS | | | | | | | | | |
| IF (140°, | Å | 136.0 | 119.0 | 125.7 | 138.1 | 114.5 | 115.9 | 115.1 | 112.5 |
| dV/dR) | | | | | | | | | |
| IS (90%, | ml/ | 70.0 | 69.0 | 77.6 | 67.4 | 69.9 | 67.4 | 65.8 | 60.0 |
| 140°, | (100 g) | | | | | | | | |
| dV/dR) | | | | | | | | | |
| PV (V80, | ml/g | 0.76 | 0.76 | 0.84 | 0.73 | 0.77 | 0.73 | 0.71 | 0.65 |
| 3.7 − 80 nm, | | | | | | | | | |
| 140°) | | | | | | | | | |
| Rₘᵢₙ (90%, | nm | 4.78 | 4.10 | 3.72 | 4.09 | 3.40 | 3.75 | 3.26 | 4.32 |
| 140°, | | | | | | | | | |
| dV/dR) | | | | | | | | | |

Modified silicas 22-29 according to the invention are produced in a spin-flash dryer. The base silicas for modification are prepared according to Example 4 from EP 0901986 B1 and Example 1 from EP 1525159 B1. The filtercake obtained is conveyed into the spin-flash dryer by means of a conveying screw. The additive is added via a conduit into the conveying unit, before the mixture thus obtained is metered into the drying chamber. The dried silicas are optionally pelletized.

The silicone oil used is Dow Xiameter™ PMX-200 Silicone Fluid polydimethylsiloxane having a viscosity of 50 cSt.

Table 4 shows the analytical data of the modified silicas.

TABLE 4

| Silicas | | 22 | 23 | 24 | 25 | 26 | 27 | 28 | 29 |
|---|---|---|---|---|---|---|---|---|---|
| Additives | | 5 phf | 8 phf | 2 phf | 15 phf | 2.7 phf | 2.7 phf | 5 phf | 8 phf |
| | | silicone | silicone | silicone | aqueous | Si 266/5.3 phf | Si 266/5.3 phf | silicone | silicone |
| | | oil | oil | oil/1 phf | Si 266 | silicone oil | silicone oil | oil | oil |
| | | | | Si 266 | emulsion | | | | |
| Drying loss | % | 3.9 | 3.6 | 3.6 | 3.0 | 3.5 | 3.5 | 3.3 | 3.1 |
| pH | — | 7.2 | 7.1 | 7.1 | 6.4 | 7.3 | 7.5 | 6.7 | 6.7 |
| BET_{MP} | m²/g | 185 | 163 | 209 | 145 | 163 | 85 | 116 | 106 |
| CTAB_{mod.} | m²/g | 109 | 104 | 120 | 85 | 105 | 63 | 87 | 83 |
| CTAB_{mod.} − | m²/g | −76 | −59 | −28 | −60 | −58 | −22 | −29 | −23 |
| BET_{MP} | | | | | | | | | |
| DOA, | ml/ | 178 | 171 | 209 | 189 | 191 | 146 | 185 | 177 |
| original | (100 g) | | | | | | | | |
| TAR_{mod.} | % | 19.2 | 20.5 | 23.7 | 20.4 | 22.9 | 27.3 | 16.4 | 16.4 |
| C content | % | 1.5 | 2.3 | 1.1 | 1.6 | 2.1 | 2.3 | 1.6 | 2.5 |
| Sulfur | % | 0.12 | 0.14 | 0.30 | 1.15 | 0.44 | 0.41 | 0.20 | 0.20 |
| content | | | | | | | | | |
| Ignition | % | 91.8 | 91.4 | 92.3 | 91.3 | 91.3 | 90.6 | 92.9 | 91.2 |
| residue | | | | | | | | | |
| Mode_{mod} | nm | 72 | 71 | 72 | 80 | 73 | 78 | 78 | 83 |
| from CPS | | | | | | | | | |
| d75_{mod} | nm | 59 | 57 | 60 | 64 | 61 | 67 | 63 | 61 |
| from CPS | | | | | | | | | |
| IF (140°, | Å | 82.8 | 82.1 | 73.1 | 119.7 | 86.9 | 154.4 | 116.0 | 121.0 |
| dV/dR) | | | | | | | | | |
| IS (90%, | ml/ | 76.5 | 72.8 | 71.6 | 76.8 | 72.7 | 73.4 | 73.0 | 72.0 |
| 140°, | (100 g) | | | | | | | | |
| dV/dR) | | | | | | | | | |
| PV (V80, | ml/g | 0.76 | 0.76 | 0.84 | 0.73 | 0.77 | 0.73 | 0.71 | 0.65 |
| 3.7 − 80 nm, | | | | | | | | | |
| 140°) | | | | | | | | | |
| Rₘᵢₙ (90%, | nm | 2.29 | 2.96 | 2.67 | 4.53 | 2.63 | 5.11 | 3.90 | 3.27 |
| 140°, | | | | | | | | | |
| dV/dR) | | | | | | | | | |

Examination of Rubber Characteristics

The materials used for the rubber mixtures are listed in Table 5. A further reference silica used was ULTRASIL® VN 3 GR from Evonik Resource Efficiency GmbH.

The recipes are shown in Table 6.

TABLE 5
List of materials used In the examples

| | |
|---|---|
| SSBR | BUNA ® VSL 4526-2, Arlanxeo Deutschland GmbH |
| BR | BUNA ® CB 24, Arlanxeo Deutschland GmbH |
| Reference | ULTRASIL ® 7000 GR, Evonik Resource Efficiency GmbH |
| silicas | ULTRASIL ® VN 3 GR, Resource Efficiency GmbH |
| | ZEOSIL ® 1165 MP, Solvay |
| Silanes | Si 266 ®, Evonik Resource Efficiency GmbH |
| | NXT, Momentive Performance Materials Inc. |
| Additives | TEGOPREN ® 5885, |
| | TEGOPREN ® 6875-45, |
| | TEGOMER ® DA 640, Evonik Nutrition & Care GmbH |
| ZnO | Rotsiegel zinc oxide, Grillo Zinkoxid GmbH |
| Stearic | Edenor ST1, Caldic Deutschland GmbH |
| acid | |
| Oil | Vivatec 500, Hansen & Rosenthal KG |
| Wax | Protektor G 3108, Paramelt B.V. |
| PPD | Vulkanox ® 4020/LG, Rhein-Chemie GmbH |
| TMQ | Vulkanox ® HS/LG, Rhein-Chemie GmbH |
| DPG | Rhenogran ® DPG-80, Rhein-Chemie GmbH |
| CBS | Vulkacit ® CZ/EG-C, Rhein-Chemie GmbH |
| Sulfur | ground sulfur, Azelis S.A. |
| TBzTD | Richon TBzTD OP, Weber & Schaer GmbH & Co. KG |

TABLE 6
Mixture formulation of the S-SBR/BR mixture

| | | | | | Reference | Reference | Reference |
|---|---|---|---|---|---|---|---|
| Mixture | 1 | 2 | 3 | 4 | 5 | 6 | 7 |
| Stage 1 | | | | | | | |
| SSBR | 96.3 | 96.3 | 96.3 | 96.3 | 96.3 | 96.3 | 96.3 |
| BR | 30 | 30 | 30 | 30 | 30 | 30 | 30 |
| Inv. mod. silica 15 | 90.6 | — | — | — | — | — | — |
| Inv. mod. silica 21 | — | 91.4 | — | — | — | — | — |
| Inv. mod. silica 19 | — | — | 90.6 | — | — | — | — |
| Inv. mod. silica 17 | — | — | — | 90.6 | — | — | — |
| ULTRASIL VN 3 GR | — | — | — | — | 80 | — | — |
| Silica 5 | — | — | — | — | — | 80 | — |
| Silica 6 | — | — | — | — | — | — | 80 |
| Si 266 | — | — | — | — | 6.4 | 6.4 | 6.4 |
| ZnO | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 |
| Oil | 8.75 | 8.75 | 8.75 | 8.75 | 8.75 | 8.75 | 8.75 |
| Wax | 2.0 | 2.0 | 2.0 | 2.0 | 2.0 | 2.0 | 2.0 |
| PPD | 2.0 | 2.0 | 2.0 | 2.0 | 2.0 | 2.0 | 2.0 |
| TMQ | 1.5 | 1.5 | 1.5 | 1.5 | 1.5 | 1.5 | 1.5 |
| Stage 2 | | | | | | | |
| Stage 1 batch | | | | | | | |
| DPG | 2.5 | 2.5 | 2.5 | 2.5 | 2.5 | 2.5 | 2.5 |
| Stage 3 | | | | | | | |
| Stage 2 batch | | | | | | | |
| CBS | 1.6 | 1.6 | 1.6 | 1.6 | 1.6 | 1.6 | 1.6 |
| Sulfur | 2.14 | 2.2 | 2.14 | 2.14 | 2.14 | 2.14 | 2.14 |
| TBzTD | 0.2 | 0.2 | 0.2 | 0.2 | 0.2 | 0.2 | 0.2 |

The rubber mixtures were produced with a GK 1.5 E internal mixer from Harburg Freudenberger Maschinenbau GmbH (Table 7).

TABLE 7
Mixture production of the S-SBR/BR mixture

| | |
|---|---|
| Stage 1 | Intermix 1.5 E temp. 65° C., 70 rpm |
| | Batch temp.: 140-155° C. |
| 0.0-0.5 min | Polymers |
| 0.5-1.0 min | TMQ, 6PPD, ⅓ filler |
| 1.0-2.0 min | ⅓ filler, any silane, ZnO, stearic acid |
| 2.0-2.0 min | Vent, purge |
| 2.0-3.0 min | a) premix carbon black and oil and add together |
| | b) 1/3 filler |
| | c) remaining constituents from the first stage |
| 3.0-3.0 min | Vent |
| 3.0-5.0 min | Mix at 140-155° C., optionally varying speed |
| | Eject |
| | About 45 s, on the roll (4 mm gap), eject sheet |
| Storage: | |
| 24 h/RT | |
| Stage 2 | Intermix 1.5 E temp. 70° C., 70 rpm |
| | Batch temp.: 140-155° C. |
| 0.0-1.0 min | Stage 1 batch |
| 1.0-3.0 min | DPG, mix at 140-155° C., optionally varying speed |
| 3.0-3.0 min | Eject |
| | About 45 s, on the roll (4 mm gap), eject sheet |

Storage: 24 h/RT

| | |
|---|---|
| Stage 3 | Intermix 1.5 E temp. 50° C., 50 rpm |
| | Batch temp.: 90-110° C. |
| 0.0-2.0 min | Stage 2 batch, accelerator, sulfur |
| 2.0-2.0 min | Eject and process on the roll for about 20 s, with |
| | gap 3-4 mm |
| Storage: | |
| 12 h/RT | |

The results of physical tests on the rubber mixtures specified here or vulcanizates thereof are listed in Table 8. The vulcanizates were produced from the untreated mixtures from the third stage by heating at 165° C. for 15 min under 130 bar. The measurements on the rubber mixtures were made by the methods described in Table 9.

TABLE 8
Results of physical tests on the rubber mixtures specified here and their vulcanizates

| | | | | | Reference | Reference | Reference |
|---|---|---|---|---|---|---|---|
| Mixture | 1 | 2 | 3 | 4 | 5 | 6 | 7 |
| Untreated mixture | | | | | | | |
| M_{S}(1 + 4) 100° C. | 36 | 34 | 36 | 37 | 45 | 47 | 42 |
| stage 2/ME | | | | | | | |
| M_{L}(1 + 4) 100° C. | 49 | 43 | 51 | 52 | 55 | 53 | 52 |
| stage 3/ME | | | | | | | |
| RPA; M_{L}/dNm | 5.9 | 4.9 | 5.6 | 6.2 | 6.7 | 6.6 | 6.5 |
| MDR; t10% | 1.4 | 1.2 | 2.0 | 1.7 | 0.6 | 1.2 | 1.5 |
| t90%/min | 3.4 | 3.4 | 3.9 | 3.9 | 4.7 | 4.4 | 4.6 |
| Vulcanizate | | | | | | | |
| DIN abrasion/mm³ | 80 | 76 | 100 | 88 | 84 | 81 | 84 |
| Tensile strength at 23° C./MPa | 16.5 | 16.2 | 16.0 | 15.4 | 13.5 | 16.5 | 16.4 |
| Elongation at break at 23° C./% | 426 | 444 | 444 | 406 | 374 | 394 | 398 |
| Tensile strength at 60° C./MPa | 9.4 | 9.7 | 10.2 | 8.8 | 9.9 | 8.4 | 9.9 |
| RPA, tan δ (max.) | 0.123 | 0.131 | 0.131 | 0.115 | 0.136 | 0.142 | 0.134 |
| Dispersion/% | 97.5 | 96.9 | 96.1 | 96.9 | 88.7 | 96.9 | 97.3 |

As apparent from Table 8, the mixtures according to the invention (1-4), compared to the references (5-7), have improved processing characteristics, as demonstrated by the reduced Mooney viscosities (mixing stages 2 and 3) and the reduction in minimum torque ML (mixing stage 3). The times at conversion t10% and t90% after mixing stage 3 also demonstrate an extended processing window with optimized vulcanization conversion. In addition, the mixtures according to the invention (1-4) show improved elongation at break with the same tensile strength compared to the reference mixtures (5-7). The dynamic properties of the vulcanized mixtures according to the invention are at a better level than those of the references (5-7), with simultaneously good abrasion properties (mixtures 1, 3 and 4) and dispersion quality.

TABLE 9

| Method | Standard |
|---|---|
| Mooney viscometer | ISO 289 |
| Mixture viscosity (ME) | |
| Moving die rheometer | DIN 53529 |
| Time at conversion t 10%, t 90% (min) | |
| Rubber process analyser (RPA) vulcanization isotherm | ASTM D7605 |
| Min. torque M_{L} (dNm) at 165° C., 1.6 Hz, 42% | |
| Vulcanizate strain sweep: tan δ (max.) at 60° C., 1.6 Hz, | |
| 0.28-42% | |
| Tensile strain on S1 test specimens at 23° C. and 60° C. | DIN 53 504 |
| Tensile strength (MPa) | |
| Elongation at break (%) | |
| Abrasion test (mm³) | DIN ISO 4649 |
| | ASTM D5963 |
| Dispersion quality of the fillers in vulcanizates (%) | ISO 11345 |
| DisperTester 3000 plus (100x) | |

1. Modified silicas, having the following physicochemical parameters:
a CTAB_{mod} of <200 m²/g,
a BET_{MP} of 50-500 m²/g,
a CTAB_{mod}-BET_{MP} of <0 m²/g,
a carbon content of >0.5% by weight,
a mode_{mod} from CPS particle size determination of >50 nm,
a d75mod from CPS particle size determination of 20-150 nm,
a Rₘᵢₙ from Hg pore size determination, pressurized of <10 nm, and
a sulfur content of ≤1.50% by weight.

2. The modified silicas of claim 1, wherein the modified silica is a modified precipitated silica.

3. The modified silicas of claim 1, wherein the sulfur content is 0.40% to 1.50% by weight.

4. The modified silicas of claim 1, that having an Ro-Tap (>300 μm) of >50%.

5. The modified silicas of claim 1, having a drying loss of <4.5% by weight.

6. The modified silicas of claim 1, having a pH of >6.3.

7. The modified silicas of claim 1, having a TAR_{mod} value of >1%.

8. The modified silicas of claim 1, having an ignition residue of 70-95%.

9. The modified silicas of claim 1, having an IF value from Hg pore size determination, pressurized, of <170 Å.

10. The modified silicas of claim 1, having an IS value from Hg pore size determination, pressurized, of <79 ml/(100 g).

11. The modified silicas of claim 1, having a PV value (V80, 3.7-80 nm, 140°) of <0.86 ml/g.

12. A process for preparing the modified silicas of claim 1, comprising: mixing silica with at least one additive selected from the group consisting of aqueous sulfur-containing alkoxysilane emulsion, polysiloxane, mixture of sulfur-containing alkoxysilane and polysiloxane, and mixture of sulfur-containing alkoxysilane and anionic polyether, in an intake of a drying unit to form a mixture, and supplying the mixture to the drying unit.

13. The process for preparing the modified silicas of claim 12, wherein the sulfur-containing alkoxysilane is bis[(3-triethoxysilyl)propyl] disulfide or (EtO)₃Si—(CH₂)₃—S—C(O)—C₇H₁₅.

14. The process for preparing the modified silicas of claim 12, wherein the polysiloxane is a modified polydimethylsiloxane having polyether phosphate, alkyl ester or polyether groups.

15. The process for preparing the modified silicas of claim 12, wherein a reaction is performed in a Henschel mixer or spin-flash dryer.

16. A rubber mixture comprising:
(A) a rubber or a mixture of rubbers; and
(B) the modified silicas of claim 1.

17. A process for producing the rubber mixture of claim 16, wherein the rubber or mixture of rubbers, the modified silicas as claimed in claim 1 and optionally further rubber auxiliaries are mixed in a mixing unit.

18. A product comprising the rubber mixture of claim 16, selected from the group consisting of pneumatic tyres, cable sheaths, hoses, drive belts, conveyor belts, roll coverings, tyres, footwear soles, gasket elements and damping elements.
